(19) United States
(12) Patent Application Publication
(10) Pub. No.: US 2025/0088542 A1
(43) Pub. Date: Mar. 13, 2025

(54) DATA SET AND ALGORITHM VALIDATION, BIAS CHARACTERIZATION, AND VALUATION

(71) Applicant: QOMPLX LLC, Reston, VA (US)

(72) Inventors: Jason Crabtree, Vienna, VA (US); Andrew Sellers, Monument, CO (US)

(21) Appl. No.: 18/957,620

(22) Filed: Nov. 22, 2024

Related U.S. Application Data
(63) Continuation of application No. 17/001,459, filed on Aug. 24, 2020, now abandoned.
Application No. 17/001,459 is a continuation-in-part of application No. 16/983,233, filed on Aug. 3, 2020, now abandoned.
Application No. 16/983,233 is a continuation-in-part of application No. 15/931,534, filed on May 13, 2020, now abandoned.
Application No. 15/931,534 is a continuation-in-part of application No. 16/777,270, filed on Jan. 30, 2020, now Pat. No. 11,025,674.
Application No. 16/777,270 is a continuation-in-part of application No. 16/720,383, filed on Dec. 19, 2019, now Pat. No. 10,944,795.
Application No. 16/720,383 is a continuation of application No. 15/823,363, filed on Nov. 27, 2017, now Pat. No. 10,560,483.
Application No. 15/823,363 is a continuation-in-part of application No. 15/725,274, filed on Oct. 4, 2017, now Pat. No. 10,609,079.
Application No. 15/725,274 is a continuation-in-part of application No. 15/655,113, filed on Jul. 20, 2017, now Pat. No. 10,735,456.
Application No. 15/655,113 is a continuation-in-part of application No. 15/616,427, filed on Jun. 7, 2017, now abandoned.
Application No. 15/616,427 is a continuation-in-part of application No. 14/925,974, filed on Oct. 28, 2015, now abandoned.
Application No. 15/655,113 is a continuation-in-part of application No. 15/237,625, filed on Aug. 15, 2016, now Pat. No. 10,248,910.
Application No. 15/237,625 is a continuation-in-part of application No. 15/206,195, filed on Jul. 8, 2016, now abandoned.
Application No. 15/206,195 is a continuation-in-part of application No. 15/186,453, filed on Jun. 18, 2016, now abandoned.
Application No. 15/186,453 is a continuation-in-part of application No. 15/166,158, filed on May 26, 2016, now abandoned.
Application No. 15/166,158 is a continuation-in-part of application No. 15/141,752, filed on Apr. 28, 2016, now Pat. No. 10,860,962.
Application No. 15/141,752 is a continuation-in-part of application No. 15/091,563, filed on Apr. 5, 2016, now Pat. No. 10,204,147.
Application No. 15/091,563 is a continuation-in-part of application No. 14/986,536, filed on Dec. 31, 2015, now Pat. No. 10,210,255.
Application No. 14/986,536 is a continuation-in-part of application No. 14/925,974, filed on Oct. 28, 2015, now abandoned.
Application No. 15/931,534 is a continuation-in-part of application No. 16/718,906, filed on Dec. 18, 2019, now Pat. No. 11,055,140.
Application No. 16/718,906 is a continuation of application No. 15/879,182, filed on Jan. 24, 2018, now Pat. No. 10,514,954.
Application No. 15/879,182 is a continuation-in-part of application No. 15/850,037, filed on Dec. 21, 2017, now abandoned.
Application No. 15/850,037 is a continuation-in-part of application No. 15/673,368, filed on Aug. 9, 2017, now abandoned.
Application No. 15/673,368 is a continuation-in-part of application No. 15/376,657, filed on Dec. 13, 2016, now Pat. No. 10,402,906.
Application No. 15/376,657 is a continuation-in-part of application No. 15/237,625, filed on Aug. 15, 2016, now Pat. No. 10,248,910.
Application No. 15/850,037 is a continuation-in-part of application No. 15/489,716, filed on Apr. 17, 2017, now abandoned.
Application No. 15/489,716 is a continuation-in-part of application No. 15/409,510, filed on Jan. 18, 2017, now abandoned.
Application No. 15/409,510 is a continuation-in-part of application No. 15/379,899, filed on Dec. 15, 2016, now abandoned.
Application No. 15/379,899 is a continuation-in-part of application No. 15/376,657, filed on Dec. 13, 2016, now Pat. No. 10,402,906.
Application No. 15/931,534 is a continuation-in-part of application No. 16/660,727, filed on Oct. 22, 2019, now Pat. No. 10,938,683.
Application No. 16/660,727 is a continuation of application No. 15/229,476, filed on Aug. 5, 2016, now Pat. No. 10,454,791.
Application No. 15/229,476 is a continuation-in-part of application No. 15/206,195, filed on Jul. 8, 2016, now abandoned.
Application No. 15/931,534 is a continuation-in-part of application No. 16/654,309, filed on Oct. 16, 2019, now abandoned.
Application No. 16/654,309 is a continuation-in-part of application No. 15/847,443, filed on Dec. 19, 2017, now abandoned.
Application No. 15/847,443 is a continuation-in-part of application No. 15/790,457, filed on Oct. 23, 2017, now Pat. No. 10,884,999.
Application No. 15/790,457 is a continuation-in-part of application No. 15/790,327, filed on Oct. 23, 2017, now Pat. No. 10,860,951.
Application No. 15/790,327 is a continuation-in-part of application No. 15/616,427, filed on Jun. 7, 2017, now abandoned.
Application No. 15/616,427 is a continuation-in-part of application No. 15/141,752, filed on Apr. 28, 2016, now Pat. No. 10,860,962.
Application No. 15/847,443 is a continuation-in-part of application No. 15/489,716, filed on Apr. 17, 2017, now abandoned.
Application No. 15/931,534 is a continuation-in-part of application No. 16/191,054, filed on Nov. 14, 2018, now Pat. No. 10,681,074.
Application No. 16/191,054 is a continuation-in-part of application No. 15/655,113, filed on Jul. 20, 2017, now Pat. No. 10,735,456.
Application No. 15/931,534 is a continuation-in-part of application No. 15/905,041, filed on Feb. 26, 2018, now Pat. No. 10,706,063.
Application No. 15/905,041 is a continuation-in-part of application No. 15/237,625, filed on Aug. 15, 2016, now Pat. No. 10,248,910.
Application No. 15/931,534 is a continuation-in-part of application No. 15/683,765, filed on Aug. 22, 2017, now abandoned.
Application No. 15/683,765 is a continuation-in-part of application No. 15/409,510, filed on Jan. 18, 2017, now abandoned.
Application No. 17/001,459 is a continuation-in-part of application No. 16/945,698, filed on Jul. 31, 2020, now abandoned.
Application No. 16/945,698 is a continuation-in-part of application No. 16/915,176, filed on Jun. 29, 2020, now abandoned.
Application No. 16/915,176 is a continuation-in-part of application No. 15/905,041, filed on Feb. 26, 2018, now Pat. No. 10,706,063.
Application No. 15/905,041 is a continuation-in-part of application No. 15/891,329, filed on Feb. 7, 2018, now abandoned.
Application No. 15/891,329 is a continuation-in-part of application No. 15/860,980, filed on Jan. 3, 2018, now abandoned.
Application No. 15/860,980 is a continuation-in-part of application No. 15/850,037, filed on Dec. 21, 2017, now abandoned.
Application No. 15/850,037 is a continuation-in-part of application No. 15/788,002, filed on Oct. 19, 2017, now abandoned.
Application No. 15/788,002 is a continuation-in-part of application No. 15/787,601, filed on Oct. 18, 2017, now Pat. No. 10,860,660.
Application No. 15/787,601 is a continuation-in-part of application No. 15/616,427, filed on Jun. 7, 2017, now abandoned.
Application No. 16/915,176 is a continuation-in-part of application No. 15/847,443, filed on Dec. 19, 2017, now abandoned.
Application No. 16/945,698 is a continuation-in-part of application No. 15/931,534, filed on May 13, 2020, now abandoned.
Application No. 15/931,534 is a continuation-in-part of application No. 16/864,133, filed on Apr. 30, 2020, now Pat. No. 11,494,665.
Application No. 16/864,133 is a continuation-in-part of application No. 15/847,443, filed on Dec. 19, 2017, now abandoned.
Application No. 16/945,698 is a continuation-in-part of application No. 16/847,443, filed on Apr. 13, 2020, now Pat. No. 11,432,095.
(60) Provisional application No. 62/568,291, filed on Oct. 4, 2017.
(60) Provisional application No. 62/568,298, filed on Oct. 4, 2017.
(60) Provisional application No. 62/568,312, filed on Oct. 4, 2017.
(60) Provisional application No. 62/568,305, filed on Oct. 4, 2017.

(51) Int. Cl. H04L 9/40; G06F 16/2458; G06F 16/951

(52) U.S. Cl. CPC H04L 63/20; G06F 16/2477; G06F 16/951; H04L 63/1425; H04L 63/1441

(57) ABSTRACT

A system and method for providing access and agency to individual entities and people over their data for the purpose of data set validation to facilitate data set and algorithm bias certification and scoring. A first data set is filtered to extract its core information content and to create a certified data set. A certified model is created by training a machine learning algorithm on the certified data set, which certified model is then used to evaluate the bias of subsequent data sets. The data set may be given a value score which represents the overall validity of the data set and its bias characterization. A bias characterization audit can help identify the root causes of bias outcomes from predictive software and algorithms that perform third party tasks and services. The score can be used as a metric to further facilitate market transactions.

### CROSS-REFERENCE TO RELATED APPLICATIONS

Priority is claimed in the application data sheet to the following patents or patent applications, each of which is expressly incorporated herein by reference in its entirety:
Ser. No. 17/001,459
Ser. No. 16/983,233
Ser. No. 15/931,534
Ser. No. 16/777,270
Ser. No. 16/720,383
Ser. No. 15/823,363
Ser. No. 15/725,274
Ser. No. 15/655,113
Ser. No. 15/616,427
Ser. No. 14/925,974
Ser. No. 15/237,625
Ser. No. 15/206,195
Ser. No. 15/186,453
Ser. No. 15/166,158
Ser. No. 15/141,752
Ser. No. 15/091,563
Ser. No. 14/986,536
Ser. No. 15/683,765
Ser. No. 15/409,510
Ser. No. 15/379,899
Ser. No. 15/376,657
Ser. No. 16/718,906
Ser. No. 15/879,182
Ser. No. 15/850,037
Ser. No. 15/673,368
Ser. No. 15/489,716
Ser. No. 16/191,054
Ser. No. 15/905,041
Ser. No. 16/654,309
Ser. No. 15/847,443
Ser. No. 15/790,457
62/568,298
Ser. No. 15/790,327
62/568,291
Ser. No. 15/847,443
Ser. No. 16/660,727
Ser. No. 15/229,476
Ser. No. 16/945,698
Ser. No. 16/864,133
Ser. No. 16/915,176
Ser. No. 15/891,329
Ser. No. 15/860,980
Ser. No. 15/788,002
62/568,305
Ser. No. 15/787,601
62/568,312
Ser. No. 15/905,041

### BACKGROUND OF THE INVENTION

### Field of the Invention

This disclosure relates to the field of computer systems, and more particularly to the field of data set validation, valuation, and bias certification.

### Discussion of the State of the Art

The proliferation of data and methods for collecting and analyzing data has birthed an industry of data brokers who currently monetize information about private entities and individuals who require third parties access their information for purposes ranging from healthcare to insurance to lending. The importance of such information has increased as ratings and tracking services have proliferated everything from auto insurance, personal and home loans, rental agreements, and even criminal sentencing. The lack of available interaction with data brokers and owners deprives many individuals and entities of fair treatment where systemic inaccuracies can result in substantial deviations in outcome across our justice system, economics, education, health, and other aspects of life. Data brokers often have little to no understanding of provenance in their actual data sets or supply chain, and in many cases build products or offer data sets which are not representative of factual aspects of the underlying entities or people. These factual errors cause algorithms to be less predictive and models to be less accurate, which can have a grave affect upon entities and individuals who rely on accurate information to pursue their actions of interest. Many modern machine learning techniques lack transparency in decision making, so understanding when predictions do not reflect reality, or the underlying bias associated with a prediction, is difficult.

What is needed is a system and method for providing access and agency to individual entities and people over their data for the purpose of data set validation to facilitate data set and algorithm bias certification and scoring.

### SUMMARY OF THE INVENTION

Accordingly, the inventor has developed and reduced to practice a system and method for providing access and agency to individual entities and people over their data for the purpose of data set validation to facilitate data set and algorithm bias certification and scoring. A first data set is filtered to extract its core information content and to create a certified data set. A certified model is created by training a machine learning algorithm on the certified data set, which certified model is then used to evaluate the bias of subsequent data sets. The data set may be given a value score which represents the overall validity of the data set and its bias characterization. A bias characterization audit can help identify the root causes of bias outcomes from predictive software and algorithms that perform third party tasks and services. The score can be used as a metric to further facilitate market transactions. The certification and scoring can be used in a data marketplace which incentivizes data brokers, providers, and consumers to contribute to the creation of a vast resource of accurate and unbiased data set collections. Individual entities and people can use a data portal where data is made available so users have the ability to correct errors within their data and otherwise engage with it.

According to a preferred embodiment, a system for data set validation, bias characterization, and valuation is disclosed, comprising: a computing device comprising a memory, a processor, and a non-volatile data storage device; a data set and model certification manager comprising a first plurality of programming instructions stored in the memory of, and operating on the processor of, the computing device, wherein the first plurality of programming instructions, when operating on the processor, cause the computing device to: retrieve a first data set from the non-volatile data storage device; pass the first data set through a series of filters to reduce the first data set to its core information content; analyze the core information content to determine an information gain for the first data set based on an entropy of the core information content; certify the data set if the information gain exceeds a threshold; create a certified model by training a machine learning algorithm with the certified data set; use the certified model to generate a baseline output using the first data set as input; and store the certified data set, the certified model, and the baseline output in the non-volatile data storage device; and a bias characterization auditor comprising a second plurality of programming instructions stored in the memory of, and operating on the processor of, the computing device, wherein the second plurality of programming instructions, when operating on the processor, cause the computing device to: receive a second data set; retrieve the certified model and the baseline output from the non-volatile data storage device; use the second data set as an input to the certified model to generate a set output; perform a bias characterization analysis by comparing the baseline output to the set output; generate a bias characterization score from the bias characterization analysis; and store the bias characterization score in the non-volatile data storage device; and a data valuation engine comprising a third plurality of programming instructions stored in the memory of, and operating on the processor of, the computing device, wherein the third plurality of programming instructions, when operating on the processor, cause the computing device to: score the second data set based on a plurality of scoring metrics, one of which is the bias characterization score; and create and store a data set value score as a weighted combination of the scores of the plurality of scoring metrics.

According to another preferred embodiment, a method for data set validation, bias characterization, and valuation is disclosed, comprising the steps of: retrieving a first data set; passing the first data set through a series of filters to reduce the first data set to its core information content; analyzing the core information content to determine an information gain for the first data set based on an entropy of the core information content; certifying the first data set if the information gain exceeds a threshold; creating a certified model by training a machine learning algorithm with the certified data set; using the certified model to generate a baseline output using the first data set as input; storing the certified data set, certified model, and the baseline output; receiving a second data set using the second data set as an input to the certified model to generate a set output; performing a bias characterization analysis by comparing the baseline output to the set output; generating a bias characterization score from the bias characterization analysis; storing the bias characterization score; scoring the second data set based on a plurality of scoring metrics, one of which is the bias characterization score; and creating and storing a data set value score as a weighted combination of the scores of the plurality of scoring metrics

According to an aspect of an embodiment, the value score is used as a pricing schedule for data set monetization.

According to an aspect of an embodiment, a bias characterization auditor is used to: receive a bias audit claim containing an audited data set; and perform the bias characterization analysis on the audited data set to create a bias characterization score for the audited data set.

According to an aspect of an embodiment, the second data set consists of: partial data, statistical characteristic data, synthetic data, a model characterizing synthetic data, or tokenized data.

According to an aspect of an embodiment, a data translator comprising a fourth plurality of programming instructions stored in the memory and operating on the processor which cause the computing device to translate a data set into one or more optional data structures while maintaining links to the original source or sources of data.

### BRIEF DESCRIPTION OF THE DRAWING FIGURES

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way.

FIG. 1 is a block diagram of an exemplary system architecture for an advanced cyber decision platform.

FIG. 2 is a block diagram of an advanced cyber decision platform in an exemplary configuration for use in investment vehicle management.

FIGS. 3A and 3B are process diagrams showing further detail regarding the operation of the advanced cyber decision platform.

FIG. 4 is a diagram of an exemplary system architecture for data set curation and

generation with crowd-based reinforcement.

FIG. 5 PRIOR ART is a diagram of an exemplary logical architecture of a generative adversarial network used as a synthetic data generator.

FIG. 6 is a flow diagram of a simplified dataset being processed by an exemplary embodiment of the system.

FIG. 7 is a diagram of an exemplary system architecture for data set and algorithm bias certification and scoring.

FIG. 8 is an exemplary data set datasheet as may be produced by an embodiment of the system.

FIG. 9 is a diagram of an exemplary process flow for data set valuation and scoring according to an embodiment of the system.

FIG. 10 is a diagram of an exemplary process flow for data set bias characterization and scoring according to an embodiment of the system.

FIG. 11 is a block diagram illustrating an exemplary hardware architecture of a computing device.

FIG. 12 is a block diagram illustrating an exemplary logical architecture for a client device.

FIG. 13 is a block diagram illustrating an exemplary architectural arrangement of clients, servers, and external services.

FIG. 14 is another block diagram illustrating an exemplary hardware architecture of a computing device.

### DETAILED DESCRIPTION OF THE INVENTION

Accordingly, the inventor has developed and reduced to practice a system and method for providing access and agency to individual entities and people over their data for the purpose of data set validation to facilitate data set and algorithm bias certification and scoring. A first data set is filtered to extract its core information content and to create a certified data set. A certified model is created by training a machine learning algorithm on the certified data set, which certified model is then used to evaluate the bias of subsequent data sets. The data set may be given a value score which represents the overall validity of the data set and its bias characterization. A bias characterization audit can help identify the root causes of bias outcomes from predictive software and algorithms that perform third party tasks and services. The score can be used as a metric to further facilitate market transactions. The certification and scoring can be used in a data marketplace which incentivizes data brokers, providers, and consumers to contribute to the creation of a vast resource of accurate and unbiased data set collections. Individual entities and people can use a data portal where data is made available so users have the ability to correct errors within their data and otherwise engage with it.

This system improves the accuracy of data sets through a combination of user curation of their information to correct factual errors and fill in gaps which may exist within their data, and certification and bias scoring. The use of a data access portal provides users agency over their data by facilitating the curation process. Data brokers generally do not know the provenance or much else about the data they compile. This unknown factor can lead to errors in downstream processes, for example landlords and renting agencies usually perform background checks on rental applicants to get an understanding of the potential risk of leasing to an applicant. These background checks are performed by third parties who access large data sets to find information about applicants. As is often the case the software the third party uses to assess the background of a person gives faulty predictions by confusing applicants with different people of the same name, which can mean the difference between having a place to live, and being homeless for those affected by the compromised prediction. The third parties who complete these services are not always aware of the inconsistencies of the underlying data sets used to enable these services.

This system will generate, for a data set, a value score which considers the provenance of the data, the quality of the data, bias, and the administrative datasheet information available. A data set is considered to have a higher value if it contains very few factual inaccuracies, has rich provenance metadata, is of high quality, and has datasheet information available. The overall score will represent the computed value of the data set and can be leveraged as the users see fit. A data broker may use a high value score to market their data sets to third party users, who in turn can justify the efficacy of their own products and services by utilizing data sets that have a high value score. Scoring and certifying data sets can help companies and large enterprises, who generate and collect vast amounts of data, identify what data is worth keeping. What this also accomplishes is that it makes predictive algorithms and models more transparent by making the data sets used for testing and training more accurate and available to all who participate in the market. This can lead to more equitable outcomes for entities and people that may have been the victim of erroneous data and biased predictions.

In the event that a biased prediction leads to a “contaminated outcome”, the system, by leveraging its provenance tracking capabilities, can “rerun” important analyses and can help identify cases where a contaminated or otherwise compromised set of decisions occurred. The system is able to keep track of decisions such as underwriting results, sentencing results, application reject/deny results, etc., and use that capability to trace back to the data set led to the compromised outcome. This improvement has immediate material benefit as there is ongoing pressure to review and hold insurers and banks accountable for discriminating against protected classes. For example, in some areas of the country judges are using algorithm driven software to determine criminal sentencing terms. The algorithms displayed a racial bias in recidivism rate for criminal sentencing which led to unjust outcomes for individuals in cases where the software was used. The bias occurred because the data sets that the software company was using was purchased from data brokers who cast a wide net to capture data, but the data the brokers caught using that net led to inconsistent, inaccurate, immaterial, and sometimes conflicting data sets. Individuals, brokers, and third parties all could benefit from a system that can identify and reduce the bias found within data sets and algorithms.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

A “database” or “data storage subsystem” (these terms may be considered substantially synonymous), as used herein, is a system adapted for the long-term storage, indexing, and retrieval of data, the retrieval typically being via some sort of querying interface or language. “Database” may be used to refer to relational database management systems known in the art, but should not be considered to be limited to such systems. Many alternative database or data storage system technologies have been, and indeed are being, introduced in the art, including but not limited to distributed non-relational data storage systems such as Hadoop, column-oriented databases, in-memory databases, and the like. While various aspects may preferentially employ one or another of the various data storage subsystems available in the art (or available in the future), the invention should not be construed to be so limited, as any data storage architecture may be used according to the aspects. Similarly, while in some cases one or more particular data storage needs are described as being satisfied by separate components (for example, an expanded private capital markets database and a configuration database), these descriptions refer to functional uses of data storage systems and do not refer to their physical architecture. For instance, any group of data storage systems of databases referred to herein may be included together in a single database management system operating on a single machine, or they may be included in a single database management system operating on a cluster of machines as is known in the art. Similarly, any single database (such as an expanded private capital markets database) may be implemented on a single machine, on a set of machines using clustering technology, on several machines connected by one or more messaging systems known in the art, or in a master/slave arrangement common in the art. These examples should make clear that no particular architectural approaches to database management is preferred according to the invention, and choice of data storage technology is at the discretion of each implementer, without departing from the scope of the invention as claimed.

A “data context,” as used herein, refers to a set of arguments identifying the location of data. This could be a Rabbit queue, a .csv file in cloud-based storage, or any other such location reference except a single event or record. Activities may pass either events or data contexts to each other for processing. The nature of a pipeline allows for direct information passing between activities, and data locations or files do not need to be predetermined at pipeline start.

As used herein, “graph” is a representation of information and relationships, where each primary unit of information makes up a “node” or “vertex” of the graph and the relationship between two nodes makes up an edge of the graph. Nodes can be further qualified by the connection of one or more descriptors or “properties” to that node. For example, given the node “James R,” name information for a person, qualifying properties might be “183 cm tall,” “DOB Aug. 13, 1965” and “speaks English”. Similar to the use of properties to further describe the information in a node, a relationship between two nodes that forms an edge can be qualified using a “label”. Thus, given a second node “Thomas G,” an edge between “James R” and “Thomas G” that indicates that the two people know each other might be labeled “knows.” When graph theory notation (Graph=(Vertices, Edges)) is applied this situation, the set of nodes are used as one parameter of the ordered pair, V and the set of 2 element edge endpoints are used as the second parameter of the ordered pair, E. When the order of the edge endpoints within the pairs of E is not significant, for example, the edge James R, Thomas G is equivalent to Thomas G, James R, the graph is designated as “undirected.” Under circumstances when a relationship flows from one node to another in one direction, for example James R is “taller” than Thomas G, the order of the endpoints is significant. Graphs with such edges are designated as “directed.” In the distributed computational graph system, transformations within transformation pipeline are represented as directed graph with each transformation comprising a node and the output messages between transformations comprising edges. Distributed computational graph stipulates the potential use of non-linear transformation pipelines which are programmatically linearized. Such linearization can result in exponential growth of resource consumption. The most sensible approach to overcome possibility is to introduce new transformation pipelines just as they are needed, creating only those that are ready to compute. Such method results in transformation graphs which are highly variable in size and node, edge composition as the system processes data streams. Those familiar with the art will realize that transformation graph may assume many shapes and sizes with a vast topography of edge relationships. The examples given were chosen for illustrative purposes only and represent a small number of the simplest of possibilities. These examples should not be taken to define the possible graphs expected as part of operation of the invention.

A “pipeline,” as used herein and interchangeably referred to as a “data pipeline” or a “processing pipeline,” refers to a set of data streaming activities and batch activities. Streaming and batch activities can be connected indiscriminately within a pipeline. Events will flow through the streaming activity actors in a reactive way. At the junction of a streaming activity to batch activity, there will exist a StreamBatchProtocol data object. This object is responsible for determining when and if the batch process is run. One or more of three possibilities can be used for processing triggers: regular timing interval, every N events, or optionally an external trigger. The events are held in a queue or similar until processing. Each batch activity may contain a “source” data context (this may be a streaming context if the upstream activities are streaming), and a “destination” data context (which is passed to the next activity). Streaming activities may have an optional “destination” streaming data context (optional meaning: caching/persistence of events vs. ephemeral), though this should not be part of the initial implementation.

As used herein, “transformation” is a function performed on zero or more streams of input data which results in a single stream of output which may or may not then be used as input for another transformation. Transformations may comprise any combination of machine, human or machine-human interactions Transformations need not change data that enters them, one example of this type of transformation would be a storage transformation which would receive input and then act as a queue for that data for subsequent transformations. As implied above, a specific transformation may generate output data in the absence of input data. A time stamp serves as an example. In the invention, transformations are placed into pipelines such that the output of one transformation may serve as an input for another. These pipelines can consist of two or more transformations with the number of transformations limited only by the resources of the system. Historically, transformation pipelines have been linear with each transformation in the pipeline receiving input from one antecedent and providing output to one subsequent with no branching or iteration. Other pipeline configurations are possible. The invention is designed to permit several of these configurations including, but not limited to: linear, afferent branch, efferent branch and cyclical.

### Conceptual Architecture

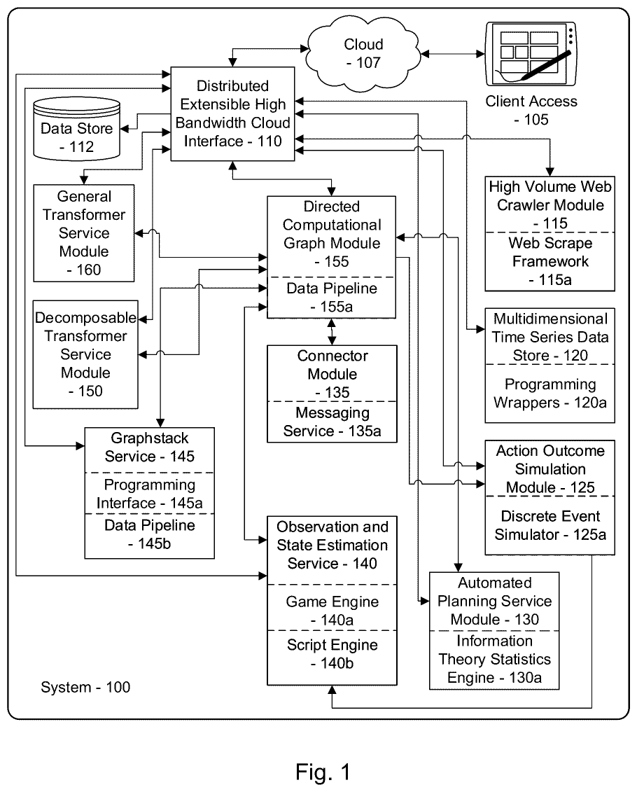

FIG. 1 is a block diagram of an advanced cyber decision platform. Client access to the system 105 for specific data entry, system control and for interaction with system output such as automated predictive decision making and planning and alternate pathway simulations, occurs through the system's distributed, extensible high bandwidth cloud interface 110 which uses a versatile, robust web application driven interface for both input and display of client-facing information via network 107 and operates a data store 112 such as, but not limited to MONGODB™, COUCHDB™, CASSANDRA™ or REDIS™ according to various arrangements. Much of the business data analyzed by the system both from sources within the confines of the client business, and from cloud based sources, also enter the system through the cloud interface 110, data being passed to the connector module 135 which may possess the API routines 135a needed to accept and convert the external data and then pass the normalized information to other analysis and transformation components of the system, the directed computational graph module 155, high volume web crawler module 115, multidimensional time series database (MDTSDB) 120 and the graph stack service 145. The directed computational graph module 155 retrieves one or more streams of data from a plurality of sources, which includes, but is in no way not limited to, a plurality of physical sensors, network service providers, web based questionnaires and surveys, monitoring of electronic infrastructure, crowd sourcing campaigns, and human input device information. Within the directed computational graph module 155, data may be split into two identical streams in a specialized pre-programmed data pipeline 155a, wherein one sub-stream may be sent for batch processing and storage while the other sub-stream may be reformatted for transformation pipeline analysis. The data is then transferred to the general transformer service module 160 for linear data transformation as part of analysis or the decomposable transformer service module 150 for branching or iterative transformations that are part of analysis. The directed computational graph module 155 represents all data as directed graphs where the transformations are nodes and the result messages between transformations edges of the graph. The high volume web crawling module 115 uses multiple server hosted preprogrammed web spiders, which while autonomously configured are deployed within a web scraping framework 115a of which SCRAPY™ is an example, to identify and retrieve data of interest from web based sources that are not well tagged by conventional web crawling technology. The multiple dimension time series data store module 120 may receive streaming data from a large plurality of sensors that may be of several different types. The multiple dimension time series data store module may also store any time series data encountered by the system such as but not limited to enterprise network usage data, component and system logs, performance data, network service information captures such as, but not limited to news and financial feeds, and sales and service related customer data. The module is designed to accommodate irregular and high volume surges by dynamically allotting network bandwidth and server processing channels to process the incoming data. Inclusion of programming wrappers 120a for languages examples of which are, but not limited to C++, PERL, PYTHON, and ERLANG™ allows sophisticated programming logic to be added to the default function of the multidimensional time series database 120 without intimate knowledge of the core programming, greatly extending breadth of function. Data retrieved by the multidimensional time series database (MDTSDB) 120 and the high volume web crawling module 115 may be further analyzed and transformed into task optimized results by the directed computational graph 155 and associated general transformer service 150 and decomposable transformer service 160 modules. Alternately, data from the multidimensional time series database and high volume web crawling modules may be sent, often with scripted cuing information determining important vertexes 145a, to the graph stack service module 145 which, employing standardized protocols for converting streams of information into graph representations of that data, for example, open graph internet technology although the invention is not reliant on any one standard. Through the steps, the graph stack service module 145 represents data in graphical form influenced by any pre-determined scripted modifications 145a and stores it in a graph-based data store 145b such as GIRAPH™ or a key value pair type data store REDIS™, or RIAK™, among others, all of which are suitable for storing graph-based information.

Results of the transformative analysis process may then be combined with further client directives, additional business rules and practices relevant to the analysis and situational information external to the already available data in the automated planning service module 130 which also runs powerful information theory 130a based predictive statistics functions and machine learning algorithms to allow future trends and outcomes to be rapidly forecast based upon the current system derived results and choosing each a plurality of possible business decisions. The using all available data, the automated planning service module 130 may propose business decisions most likely to result is the most favorable business outcome with a usably high level of certainty. Closely related to the automated planning service module in the use of system derived results in conjunction with possible externally supplied additional information in the assistance of end user business decision making, the action outcome simulation module 125 with its discrete event simulator programming module 125a coupled with the end user facing observation and state estimation service 140 which is highly scriptable 140b as circumstances require and has a game engine 140a to more realistically stage possible outcomes of business decisions under consideration, allows business decision makers to investigate the probable outcomes of choosing one pending course of action over another based upon analysis of the current available data.

When performing external reconnaissance via a network 107, web crawler 115 may be used to perform a variety of port and service scanning operations on a plurality of hosts. This may be used to target individual network hosts (for example, to examine a specific server or client device) or to broadly scan any number of hosts (such as all hosts within a particular domain, or any number of hosts up to the complete IPv4 address space). Port scanning is primarily used for gathering information about hosts and services connected to a network, using probe messages sent to hosts that prompt a response from that host. Port scanning is generally centered around the transmission control protocol (TCP), and using the information provided in a prompted response a port scan can provide information about network and application layers on the targeted host.

Port scan results can yield information on open, closed, or undetermined ports on a target host. An open port indicated that an application or service is accepting connections on this port (such as ports used for receiving customer web traffic on a web server), and these ports generally disclose the greatest quantity of useful information about the host. A closed port indicates that no application or service is listening for connections on that port, and still provides information about the host such as revealing the operating system of the host, which may be discovered by fingerprinting the TCP/IP stack in a response. Different operating systems exhibit identifiable behaviors when populating TCP fields, and collecting multiple responses and matching the fields against a database of known fingerprints makes it possible to determine the OS of the host even when no ports are open. An undetermined port is one that does not produce a requested response, generally because the port is being filtered by a firewall on the host or between the host and the network (for example, a corporate firewall behind which all internal servers operate).

Scanning may be defined by scope to limit the scan according to two dimensions, hosts and ports. A horizontal scan checks the same port on multiple hosts, often used by attackers to check for an open port on any available hosts to select a target for an attack that exploits a vulnerability using that port. This type of scan is also useful for security audits, to ensure that vulnerabilities are not exposed on any of the target hosts. A vertical scan defines multiple ports to examine on a single host, for example a “vanilla scan” which targets every port of a single host, or a “strobe scan” that targets a small subset of ports on the host. This type of scan is usually performed for vulnerability detection on single systems, and due to the single-host nature is impractical for large network scans. A block scan combines elements of both horizontal and vertical scanning, to scan multiple ports on multiple hosts. This type of scan is useful for a variety of service discovery and data collection tasks, as it allows a broad scan of many hosts (up to the entire Internet, using the complete IPv4 address space) for a number of desired ports in a single sweep.

Large port scans involve quantitative research, and as such may be treated as experimental scientific measurement and are subject to measurement and quality standards to ensure the usefulness of results. To avoid observational errors during measurement, results must be precise (describing a degree of relative proximity between individual measured values), accurate (describing relative proximity of measured values to a reference value), preserve any metadata that accompanies the measured data, avoid misinterpretation of data due to faulty measurement execution, and must be well-calibrated to efficiently expose and address issues of inaccuracy or misinterpretation. In addition to these basic requirements, large volumes of data may lead to unexpected behavior of analysis tools, and extracting a subset to perform initial analysis may help to provide an initial overview before working with the complete data set. Analysis should also be reproducible, as with all experimental science, and should incorporate publicly-available data to add value to the comprehensibility of the research as well as contributing to a “common framework” that may be used to confirm results.

When performing a port scan, web crawler 115 may employ a variety of software suitable for the task, such as Nmap, ZMap, or masscan. Nmap is suitable for large scans as well as scanning individual hosts, and excels in offering a variety of diverse scanning techniques. ZMap is a newer application and unlike Nmap (which is more general-purpose), ZMap is designed specifically with Internet-wide scans as the intent. As a result, ZMap is far less customizable and relies on horizontal port scans for functionality, achieving fast scan times using techniques of probe randomization (randomizing the order in which probes are sent to hosts, minimizing network saturation) and asynchronous design (utilizing stateless operation to send and receive packets in separate processing threads). Masscan uses the same asynchronous operation model of ZMap, as well as probe randomization. In masscan however, a certain degree of statistical randomness is sacrificed to improve computation time for large scans (such as when scanning the entire IPv4 address space), using the BlackRock algorithm. This is a modified implementation of symmetric encryption algorithm DES, with fewer rounds and modulo operations in place of binary ones to allow for arbitrary ranges and achieve faster computation time for large data sets.

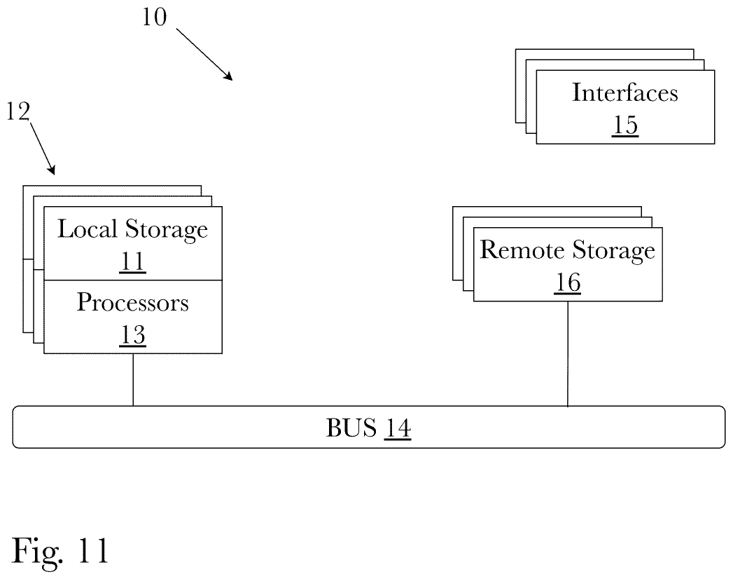

Received scan responses may be collected and processed through a plurality of data pipelines 155a to analyze the collected information. MDTSDB 120 and graph stack 145 may be used to produce a hybrid graph/time-series database using the analyzed data, forming a graph of Internet-accessible organization resources and their evolving state information over time. Customer-specific profiling and scanning information may be linked to CPG graphs (as described below in detail, referring to FIG. 11) for a particular customer, but this information may be further linked to the base-level graph of internet-accessible resources and information. Depending on customer authorizations and legal or regulatory restrictions and authorizations, techniques used may involve both passive, semi-passive and active scanning and reconnaissance.

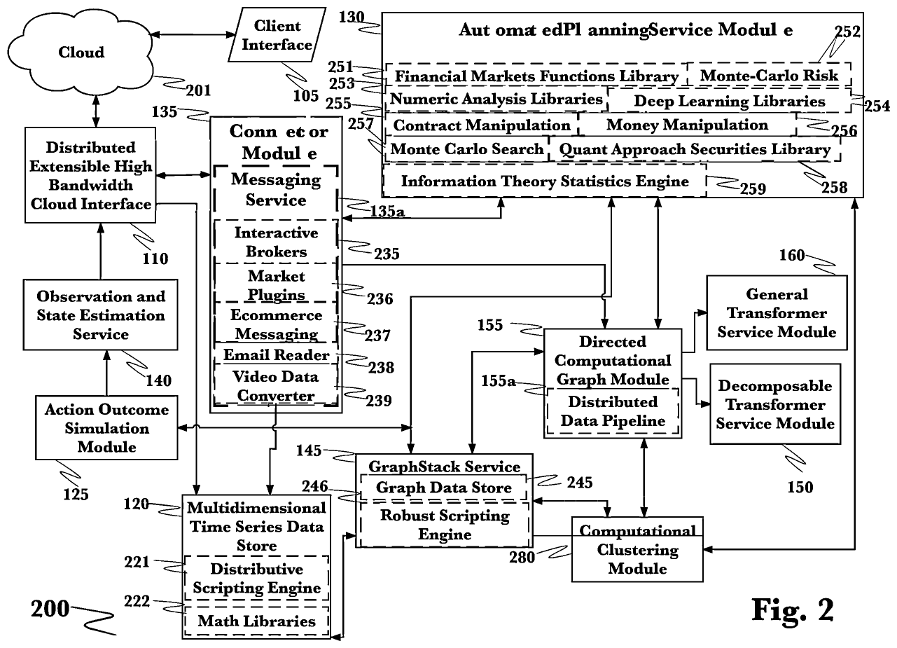

FIG. 2 is a block diagram of an advanced cyber decision platform in an exemplary configuration for use in investment vehicle management 200. The advanced cyber decision platform 100 previously disclosed in co-pending application Ser. No. 15/141,752 and applied in a role of cybersecurity in co-pending application Ser. No. 15/237,625, when programmed to operate as quantitative trading decision platform, is very well suited to perform advanced predictive analytics and predictive simulations 202 to produce investment predictions. Much of the trading specific programming functions are added to the automated planning service module 130 of the modified advanced cyber decision platform 100 to specialize it to perform trading analytics. Specialized purpose libraries may include but are not limited to financial markets functions libraries 251, Monte-Carlo risk routines 252, numeric analysis libraries 253, deep learning libraries 254, contract manipulation functions 255, money handling functions 256, Monte-Carlo search libraries 257, and quant approach securities routines 258. Pre-existing deep learning routines including information theory statistics engine 259 may also be used. The invention may also make use of other libraries and capabilities that are known to those skilled in the art as instrumental in the regulated trade of items of worth. Data from a plurality of sources used in trade analysis are retrieved, much of it from remote, cloud resident 201 servers through the system's distributed, extensible high bandwidth cloud interface 110 using the system's connector module 135 which is specifically designed to accept data from a number of information services both public and private through interfaces to those service's applications using its messaging service 135a routines, due to ease of programming, are augmented with interactive broker functions 235, market data source plugins 236, e-commerce messaging interpreters 237, business-practice aware email reader 238 and programming libraries to extract information from video data sources 239.

Other modules that make up the advanced cyber decision platform may also perform significant analytical transformations on trade related data. These may include the multidimensional time series data store 120 with its robust scripting features which may include a distributive friendly, fault-tolerant, real-time, continuous run prioritizing, programming platform such as, but not limited to Erlang/OTP 221 and a compatible but comprehensive and proven library of math functions of which the C++ math libraries are an example 222, data formalization and ability to capture time series data including irregularly transmitted, burst data; the GraphStack service 145 which transforms data into graphical representations for relational analysis and may use packages for graph format data storage such as Titan 245 or the like and a highly interface accessible programming interface an example of which may be Akka/Spray, although other, similar, combinations may equally serve the same purpose in this role 246 to facilitate optimal data handling; the directed computational graph module 155 and its distributed data pipeline 155a supplying related general transformer service module 160 and decomposable transformer module 150 which may efficiently carry out linear, branched, and recursive transformation pipelines during trading data analysis may be programmed with multiple trade related functions involved in predictive analytics of the received trade data. Both possibly during and following predictive analyses carried out by the system, results must be presented to clients 105 in formats best suited to convey the both important results for analysts to make highly informed decisions and, when needed, interim or final data in summary and potentially raw for direct human analysis. Simulations which may use data from a plurality of field spanning sources to predict future trade conditions these are accomplished within the action outcome simulation module 125. Data and simulation formatting may be completed or performed by the observation and state estimation service 140 using its ease of scripting and gaming engine to produce optimal presentation results.

In cases where there are both large amounts of data to be cleansed and formalized and then intricate transformations such as those that may be associated with deep machine learning, first disclosed in ¶067 of co-pending application Ser. No. 14/925,974, predictive analytics and predictive simulations, distribution of computer resources to a plurality of systems may be routinely required to accomplish these tasks due to the volume of data being handled and acted upon. The advanced cyber decision platform employs a distributed architecture that is highly extensible to meet these needs. A number of the tasks carried out by the system are extremely processor intensive and for these, the highly integrated process of hardware clustering of systems, possibly of a specific hardware architecture particularly suited to the calculations inherent in the task, is desirable, if not required for timely completion. The system includes a computational clustering module 280 to allow the configuration and management of such clusters during application of the advanced cyber decision platform. While the computational clustering module is drawn directly connected to specific co-modules of the advanced cyber decision platform these connections, while logical, are for ease of illustration and those skilled in the art will realize that the functions attributed to specific modules of an embodiment may require clustered computing under one use case and not under others. Similarly, the functions designated to a clustered configuration may be role, if not run, dictated. Further, not all use cases or data runs may use clustering.

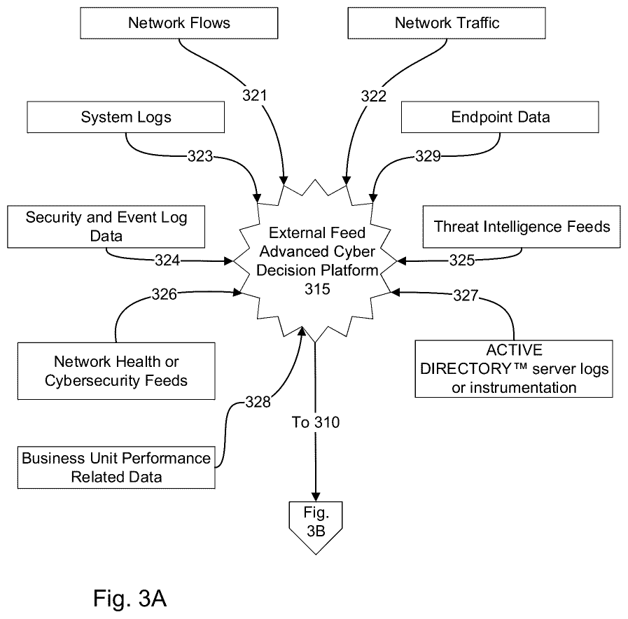

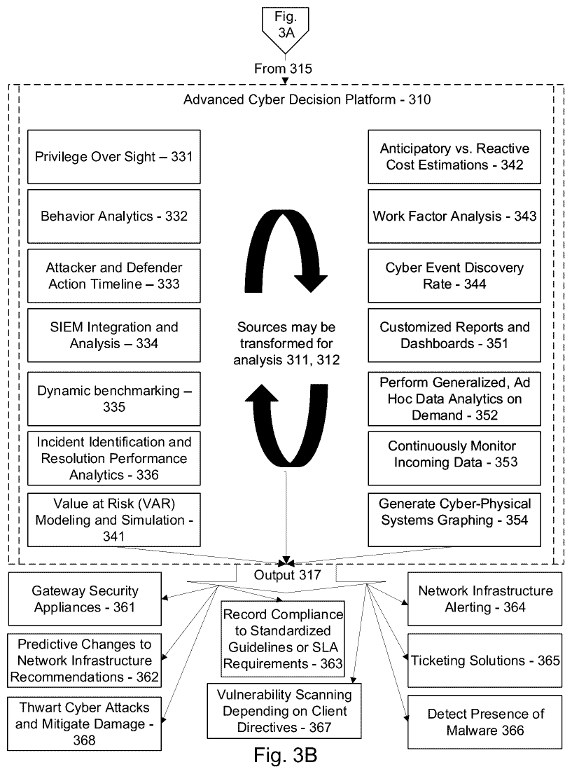

FIGS. 3A and 3B are process diagrams showing further detail regarding the operation of the advanced cyber decision platform. Input network data which may include network flow patterns 321, the origin and destination of each piece of measurable network traffic 322, system logs from servers and workstations on the network 323, endpoint data 329, any security event log data from servers or available security information and event (SIEM) systems 324, external threat intelligence feeds 324, identity or assessment context 325, external network health or cybersecurity feeds 326, Kerberos domain controller or ACTIVE DIRECTORY™ server logs or instrumentation 327, business unit performance related data 328, endpoint data 329, among many other possible data types for which the invention was designed to analyze and integrate, may pass into 315 the advanced cyber decision platform 310 for analysis as part of its cyber security function. These multiple types of data from a plurality of sources may be transformed for analysis 311, 312 using at least one of the specialized cybersecurity, risk assessment or common functions of the advanced cyber decision platform in the role of cybersecurity system, such as, but not limited to network and system user privilege oversight 331, network and system user behavior analytics 332, attacker and defender action timeline 333, SIEM integration and analysis 334, dynamic benchmarking 335, and incident identification and resolution performance analytics 336 among other possible cybersecurity functions; value at risk (VAR) modeling and simulation 341, anticipatory vs. reactive cost estimations of different types of data breaches to establish priorities 342, work factor analysis 343 and cyber event discovery rate 344 as part of the system's risk analytics capabilities; and the ability to format and deliver customized reports and dashboards 351, perform generalized, ad hoc data analytics on demand 352, continuously monitor, process and explore incoming data for subtle changes or diffuse informational threads 353 and generate cyber-physical systems graphing 354 as part of the advanced cyber decision platform's common capabilities. Output 317 can be used to configure network gateway security appliances 361, to assist in preventing network intrusion through predictive change to infrastructure recommendations 362, to alert an enterprise of ongoing cyberattack early in the attack cycle, possibly thwarting it but at least mitigating the damage 362, to record compliance to standardized guidelines or SLA requirements 363, to continuously probe existing network infrastructure and issue alerts to any changes which may make a breach more likely 364, suggest solutions to any domain controller ticketing weaknesses detected 365, detect presence of malware 366, perform one time or continuous vulnerability scanning depending on client directives 367, and thwart or mitigate damage from cyber-attacks 368. These examples are, of course, only a subset of the possible uses of the system, they are exemplary in nature and do not reflect any boundaries in the capabilities of the invention.

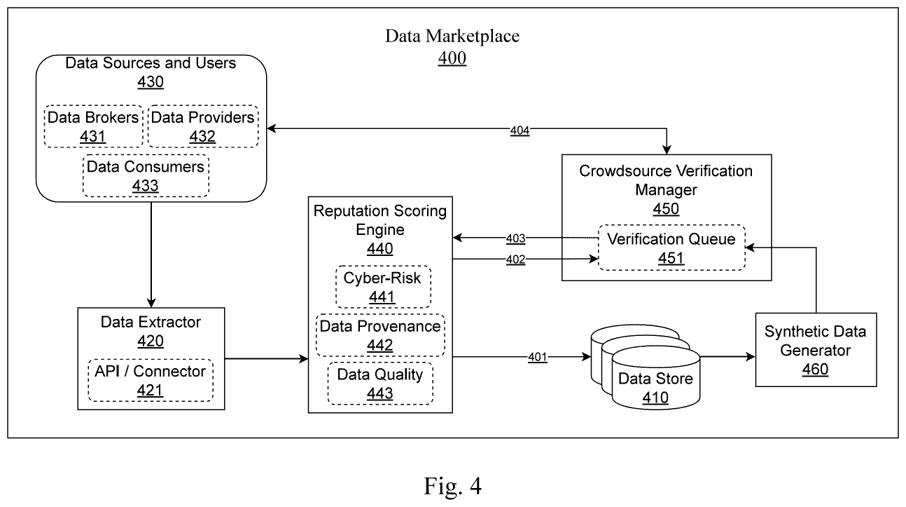

FIG. 4 is a diagram of an exemplary system architecture for data set curation and generation with crowd-based reinforcement. According to one embodiment, a data marketplace 400 is a growing data ecosystem that allows data brokers 431, providers 432, and consumers 433 the ability to contribute and curate data to create a mutually beneficial store 410 of reliable and large data set collections. The data marketplace 400 may utilize any number of marketing and business models to recruit, employ, and compensate businesses and individuals in this enterprise.

According to an aspect of this embodiment, a data extractor 420 comprises a series of ingestion APIs and connectors 421 that retrieve or receive commercial and public data sets from data brokers 431 and providers 432. Additional embodiments may include the ingestion of unstructured data and various other structured data sources. A reputation scoring engine 440 processes the ingested data 402 and assigns a reputation score. The reputation score is comprised of a cyber-risk score 441, data provenance score 442, and a data quality score 443.

The cyber-risk score is generated from information gathered about the source of the data. This may include the data broker's 431 or provider's 432 operations, including such information as business processes and policies, business process dependencies, prior data loss information and security breaches, and behavioral data for both devices and their users. The scoring may further comprise active and passive internal and external reconnaissance of the organization to determine cybersecurity vulnerabilities and potential impacts to the data set in light of the information gathered about the organization's infrastructure and operations. As an example, data breaches may imply compromised data sets and would lower the cyber-risk portion of the reputation score by a significant amount. Detailed information about reconnaissance for cybersecurity applications is contained in U.S. patent application Ser. No. 16/777,270, which is incorporated herein by reference.

The data provenance score 442 is based on the chain of custody or path data has taken. This includes consideration of the hardware and software that has processed the data where potential vulnerabilities associated with specific hardware and software may allow malicious actors to alter data. Also analyzed are the users which have accessed or modified the data. Whether or not the data has followed all imposed data restrictions such as the European Union's general data protection regulations or other legal or regulatory compliance mechanisms. Detailed information about a system and method for data provenance is contained in U.S. patent application Ser. No. 15/931,534, which is incorporated herein by reference.

The data quality score 443 quantifies the quality of the data for its intended purpose. In one embodiment, the data quality score 443 is based on six metrics. The first metric is the completeness of the data. The percentage of completeness reduces in the absence of critical data fields. The second metric is uniqueness. More distinct data leads to better results so the reputation scoring engine compares newly ingested data with itself and with data already stored within the marketplace. Uniqueness may be determined as one hundred percent if the number of new data items is unique and equal to the number of data items in the available data set. The third metric is timeliness. Certain applications require up to date information such as some financial, navigational, and cybersecurity models. Stock market data from the 1930's may not be as relevant today as from the earlier 2000's. Validity is the fourth metric and parallels the cyber-risk score 441 in that it examines the hardware and software that accesses the data. However, it determines the physical and logical integrity by analyzing event logs. Data that was recreated from a failed persistence layer (e.g., RAID) is an example of a physical integrity issue where incomplete or inconsistent logs may be one example of a logical integrity issue. Data accuracy is fifth in the overall data quality score 443. Data which accurately represents the real-world context gains a higher score than poorly modeled references. Typically, the more data fields the better, however, this is not always the case. Data sets about automobiles may have a significant quantity of data fields such as the number of gauges in the dash cluster or whether an automobile has an integrated compact disc player, but the majority of which may not be useful to most applications; however, sanitized medical records may share a similar amount of data fields containing symptoms but would prove useful in many machine learning models. Lastly, consistency measures the data against itself but from other sources with similar specifications.

Regarding the three main components of the reputation score, namely cyber-risk 441, data provenance 442, and data quality 443, machine learning algorithms may handle a majority of the assigned tasks. Any scoring metric that produces an error, outlier, or unknown result is earmarked 402 for the queue 451 in a crowdsource verification manager 450. Any ingested data that meets a specified threshold of reputability may be automatically merged and persisted 401 in the marketplace data store 410 without the need for human intervention 450. According to one embodiment, qualified users 430, known as data stewards from here out, may navigate to a web-interface or be notified by email or other communication of the opportunity 404 to curate data in the queue 451. Data stewards are then presented with the queued data along with the earmarked criteria. The data steward performs alterations or corrections on the data, provides direction or clarification for the reputation scoring engine 440, or marks the data as unsalvageable. Examples of actions a user might perform on data from the queue 451 comprises filling in missing data, resolving merge conflicts, converting data formats, updating old information, confirming large batch jobs, scheduled auditing, creating labels, and various other data cleansing and preprocessing functions. Once the proper actions have taken place on the data, it is sent back 403 to the reputation scoring engine 440 for another evaluation. This will iterate through the data until the threshold of reputability has been met and the data can be stored in a persistence layer 410. An additional aspect of the dynamics between the reputation scoring engine 440 and the crowdsource verification manager 450 is that corrections made by the data steward may be fed back into the machine learning model to improve the reputation scoring engine's 440 accuracy. Additional embodiments may comprise having established users verify actions performed in the queue by new users so as to mitigate inaccurate and costly errors.

Inadequate data set collections persisted in the data store 410 are identified either by continuously low reputation scores or a demand from data consumers 433 and initiate a synthetic data generator 460 to start a data generation job. Relevant data from the data store 410 is sent as training data to the synthetic data generator 460. The synthetic data generator generates synthetic data from the high quality curated data from the crowdsource verification manager 450 and reputation scoring engine 440. Data from the synthetic data generator 460 is fed into the verification queue 451. Data stewards verify the veracity of the synthetic data and upon completion the data goes into the reputation scoring engine 440. After a reputable score is met, the data is then merged with the stored data in the persistence layer 410.

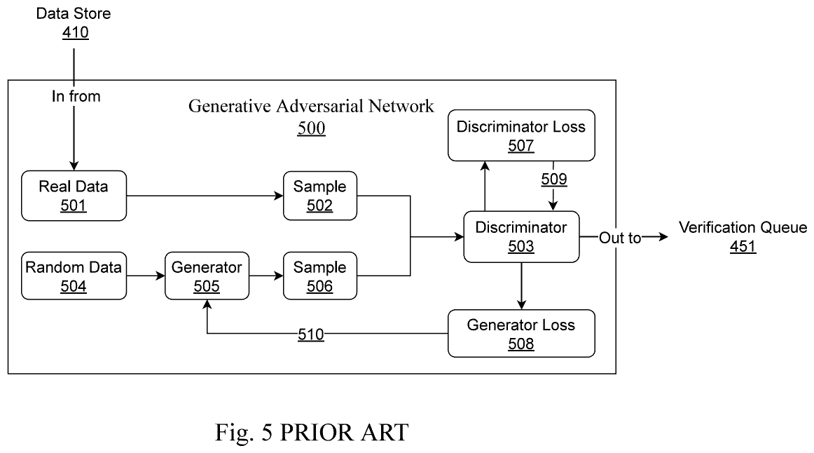

FIG. 5 PRIOR ART is a diagram of an exemplary logical architecture of a generative adversarial network 500 used as a synthetic data generator. The reputation scoring engine from FIG. 4 flags specific data set collections which need additional data for any reason. All relevant reputable data stored in the data store 410 gets sent as training data or otherwise known as real data 501 in the context of generative adversarial networks (GAN) to the generative adversarial network 500. The reputation scoring engine may also be configured to queue 451 the training data for review by a data steward before sending the data to the generative adversarial network 500.

A sample 502 of real data 501 is sent to the discriminator 503 and compared against a sample 506 of random data 504 output by the generator 505. The generative adversarial network 500 trains the generator 505 and discriminator 503 during alternate iterations via back propagation. Otherwise stated, the output values of each iteration (discriminator loss 507 or generator loss 508 during discriminator training and generator training, respectively) are calculated (and cached) in a forward pass. Then, the partial derivative of the error with respect to each parameter is calculated in a backward pass 509, 510 through the graph.

The generator 505 and discriminator 503 operate in a competitive relationship. The discriminator 503 learns to tell the difference between real 502 and synthetic data 506 while the generator 505 learns to create more convincing synthetic data 506. Once the generator can output samples 506 with a fifty percent succession rate (according to one embodiment), the discriminator 503 sends the sample 506 to the verification queue 451. At the queue 451, data stewards are compensated for verifying the accuracy or making corrections to the synthetic data with relation to the real data. This auditing of synthetic data solves the problem of overfitting and biases GANs are prone to.

An example of this system is generating stock market orders for financial research that requires huge volumes of data. Additionally, real-world data offers only one historical view and provides no lateral understanding of variances that could have happened in the market. Therefore, the synthetic data generator may be employed to generate synthetic stock market data and evaluate it against real-world stock market streams to produce valuable alternative data options for market researchers. The discriminator 503 would use a plurality of key determinates such as the distribution of price and quantity of orders, inter-arrival times of orders, and the highest bid and highest ask evolution over time to comparatively measure the synthetic data 506. Synthetic data 506 once found to be reputable by the data marketplace, would merge with stored real data increasing the overall volume of the financial data set collection.

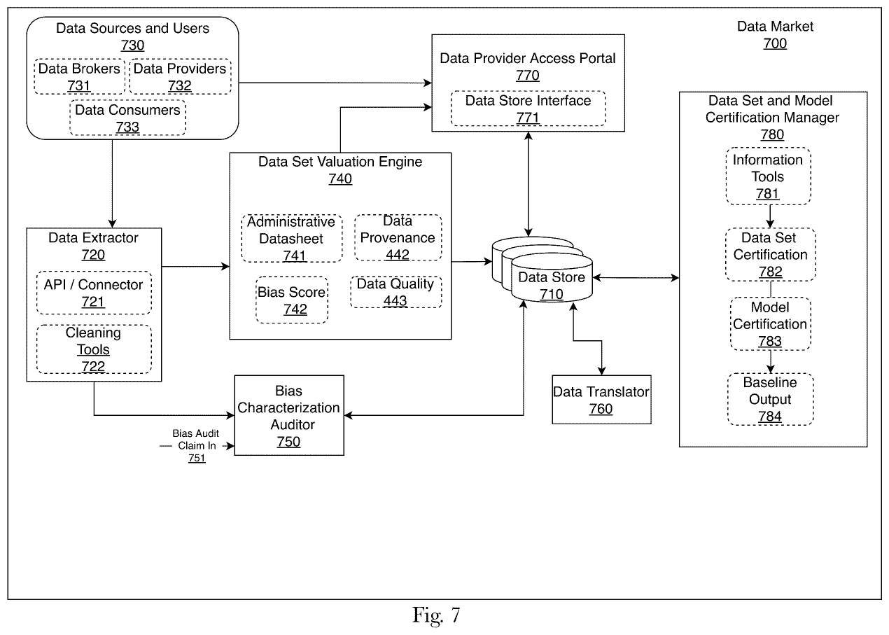

FIG. 7 is a diagram of an exemplary system architecture for data set and algorithm bias certification and scoring. According to one embodiment, a data marketplace 700 is a growing data ecosystem that allows data brokers 731, providers 732, and consumers 733 the ability to contribute and curate data to create a mutually beneficial store 710 of reliable and large data set collections. The data marketplace 700 may utilize any number of marketing and business models to recruit, employ, and compensate businesses and individuals in this enterprise.

According to an aspect of this embodiment, a data extractor 720 comprises a series of ingestion APIs and connectors 721 that retrieve or receive commercial and public data sets from data brokers 731 and providers 732, as well as a plurality of data cleaning tools 722 for data set quality monitoring on ingest. An example of a cleaning tool 722 is SLIMFast which utilizes a data fusion method to resolve data conflicts across sources by estimating their trustworthiness, and using that to estimate as an initial value of each data object. The cleaning tools act as a preliminary filter within the data integration pipeline that moves data from the data extractor 720 to the data store 710. Material changes to schema, noise in the data (e.g. via identification of suspicious or aberrant values), etc. are potentially impactful on downstream processes such as predicative modeling, so inspecting data objects on ingest provides another layer for data validation. Additional embodiments may include the ingestion of unstructured data and various other structured data sources. Sometimes, data sets are partially or fully restricted from being accessed and used for analysis. If access to a data set is restricted, then the system has the optional ability to gain raw access, partial sample access, or if there is no access to data, to statistical characteristics or synthetic, a model characterizing synthetic data, or tokenized alternatives the data. The system may perform analyses on individual data sets or baskets (i.e., aggregates or groups) of data sets. Raw access means that the raw data a data set is sourced from is available and can be analyzed in place of the data set. Partial sample data refers to small subset of data which may or may not be representative of the data content contained within a full data set. If data set access is fully restricted then the system can analyze a data set based on any available statistical characteristics that provide information about the quantity, quality, content, fitness, etc. of a data set. Additionally, the system can use synthetic data in lieu of a restricted data set. Synthetic data is generated via machine learning processes that produce machine generated data which is continuously cultivated until it satisfies the constraints for being a useful data set. Conscientious generation of synthetic data makes for synthetic data sets that are nearly indistinguishable from data sets compiled by real data. Detailed information about synthetic data and synthetic data generation is contained in the patent application Ser. No. 16/983,233, which has been incorporated herein by reference. Tokenized data can be analyzed if the data contained within a data set is restricted or sensitive in nature. A token is a reference (i.e. identifier) that maps back to sensitive data through a tokenization system. The system contained within this patent application can perform analysis on tokenized data or data sets, which do not change the original non-tokenized data set. A data set valuation engine 740 processes the persisted data sets, assigns a value score, and produces a value score report. The value score is comprised of an administrative datasheet score 741, bias score 742, data provenance score 442, and a data quality score 443.

The administrative datasheet score 741 is based upon the available information that satisfies one or more of a plurality of categories such as the: motivation of data set creation, data set composition, data collection process, data preprocessing, data set distribution, data set maintenance, legal and ethical considerations. As artificial intelligence (AI) systems become more ubiquitous in everyday tasks and decision making there will be a need to have standards to enforce safe practices in regards to the creation and distribution of data sets for algorithmic processes. When cars were first conceived there were no safety standards and regulations as they exist today. It was over the course of time, as car use grew more prevalent and there were more incidents and precedents, that regulations began to govern the creation and distribution of vehicles. Likewise, AI technology and data sets are on course to be standardized to ensure proper use and safe practices. Indeed, regulations such as the European General Data Protection Regulation (GDPR) and the California Consumer Privacy Act (CCPA) have granted affected citizens more rights and protections over their data and its use.

A data set datasheet is similar to electronic device datasheets in that it contains vital information about the data set that gives users a clear understanding of its capabilities and limitations. A data set that is accompanied by a datasheet, or even a partial datasheet, is given a higher score than a data set that has very little to no administrative datasheet 741 information. The score is higher because a datasheet can facilitate better communication between set creators and users, which gives an opportunity for domain experts to share what they know about a data set and its limitations to developers or brokers who might use it. Datasheets also encourage the machine learning community to prioritize transparency and accountability for the results of its predictive models. A well-documented datasheet can greatly affect the value of a data set, which makes the data set more marketable for potential monetization actions. This further incentivizes participants in the data market to contribute their data sets with any accompanying datasheet information. After a data set value score is generated, the value is then linked with the stored data set in the persistence layer 710. A byproduct of the data set valuation process is the ability to better categorize and register information held by data brokers in a fully accessible data store 710.

According to an embodiment, data providers 732 can engage with their data via a data provider access portal 770 that consists of a data store interface 771. The access portal 770 could be provided by, but not limited to mobile phone app, website, virtual access, human-human interaction, human-machine interaction, software program, and the like. The data store interface 771 allows users to perform tasks including, but not limited to view data sets contained within the data market ecosystem, search for and view individual data, correct individual factual data errors, fill in missing gaps in their data, view data set scores, view use histories and transactions involving a data set, etc. The interface 771 may be implemented by a plurality of methods such as command line interface, graphical user interface (GUI), menu driven, natural language, or any suitable method known by those skilled in the arts. The access portal 770 gives individual entities and people agency over their data which enhances the vitality of the market by means of more valuable data and data sets being compiled and made readily available. Changes made to data and data sets are persisted into the data store 710. The dataset valuation engine 740 can generate both a new value score and value score report for the user updated data set.

The data market 700 also contains a bias characterization auditor (BCA) 750. The purpose of the BCA 750 is to automatically generate a bias characterization score 742 for a data set as it is ingested by the data extractor 720, and also to mediate situations where a biased algorithm led to contaminated predictions and outcomes. The data market 700 will leverage its provenance tracking system to keep track of decisions such as underwriting results, sentencing results, application reject/deny results, etc., and use that capability to trace back to the data set which led to the compromised outcome. Detailed information about data provenance tracking is contained in U.S. patent application Ser. No. 15/931,534, which has been incorporated herein by reference. In this context, contaminated refers to a decision that had a material adverse outcome for individual entities or people. As was the case in the above example about a rental applicant being denied an apartment because the third party that performed a background check used data of the wrong person to make its prediction, that would be considered a contaminated and compromised process. According to an embodiment, if a third party is providing biased products and services, then the BCA 750 may receive a bias audit claim 751 to characterize the audited data sets that were used to develop the third party products. The audited data set is received by the BCA 750 and the certified model appropriate for the use case will be retrieved from the data store 710 to identify what led to biases within the data sets. If the bias was due to insufficient data, then the BCA 750 will flag that data set as needing more information and persisted back to the data store 710. Flagged data sets can be viewed in the data store interface 771 so that entities and people may add to the data set to improve the accuracy. The BCA 750 will also locate, via tag and keyword search, data sets that contain similar information but have a higher value score, to use in place of the biased data set.

The data set and model certification manager 780 will retrieve a data set from the data store 710 and employ information tools 781 for determining a data set's informational content to facilitate the careful cultivation of testing data from training data to certify a data set as appropriate for machine learning processes. Cultivation of testing data can be facilitated using a plurality of methods; the data set and model certification manager 780 is able to evaluate individual data sets or baskets of data sets using various information tools 781 for information gain to determine the best data sets for testing and training of machine learning algorithms. Identifying the informational gain of a data set further validates its usefulness and makes the data set more valuable in terms predictive machine leaning processes.

According to an embodiment, a data translator 760 receives a data set and is capable of translating data sets into one or more optional data representations while maintaining links to the original source or sources of data. A data representation refers to the format, organization, or structure of a data set. Optional data representations may include, in some embodiments, translating the data set for use in a different data model from the one for which the data set was created. In some cases data representations may act as indices to, or aggregations of, one or more data sets. This is beneficial as some types of analysis are highly dependent on the organization of data (e.g. wide column vs graph). The data translator 760 is further facilitated by the use of an asset registry, which can register assets and keep track of parent and child processes associated with the asset, and generic SparkService jobs for batch translations of data sets. Detailed information about asset registry is contained in U.S. patent Ser. No. 16/945,698 which has been incorporated herein by reference. In the context of the system contained within this disclosure the ingested data sets are assets, and any translations, transformations, upstream or downstream processes, are child processes and persisted as metadata that links the original data set or data source with all dependent processes. The data translator 760 can manipulate a data set creating multiple views of the same data set, including partial views of the data set where the context requires. Each view of the data set can undergo individual analyses which are linked to the original data set via the registry capabilities. Individual views and their respective analyses when combined, act as indices from one data model to another for the original data set.

In an embodiment, information tools 781 include techniques such as an information sieve which can leverage entropy-based mechanisms for determining information gain of any particular data set when viewed in concert with its alternatives and substitutes. In an embodiment, an entropy based mechanism determines the information gain of a data set by passing the data set through a series of filters; at each filter extraneous data or information is removed from the data set. After the data set has progressed through the series of filters, what is left is a data set that better represents the core information content of the original data set, which can then be analyzed to determine its information gain. The information gain of a data set corresponds to the novelty or uniqueness of a data set and of its predictive value from a machine learning process. The entropy of a data set can be thought of as the amount of variance the data has. Higher entropy corresponds to more information content and thus more information gain, meaning that the data would be particularly useful as a training set for machine learning algorithms. Conversely, a lower entropy value corresponds to less information gain, meaning that the data would not be useful as a training set for a machine learning process. If the information gain of data set surpasses a predefined threshold, then the data set has satisfied the requirements to become a certified data set 782. These certified data sets 782 are used by the data set and model certification manager 780 to create a certified model 783 which is leveraged to generate a baseline output 784 which is persisted to the data store 710 for further use by the BCA 750. The baseline output 784 is simply the output of the certified model 783 when the input to the model was a certified data set 782 A certified data set 782 has been analyzed for information gain and may be processed to remove any underlying biases associated with the data set. A certified training set 782 may also contain segmented data for explicit training and testing purposes only. A certified model is created by training a machine learning algorithm with one or more certified data sets 782 such that the trained machine learning algorithm can produce accurate predictive outcomes with little to no bias. For example, if a certified model for age prediction developed from a certified data set 782 of facial images with age information can accurately predict the age of a person to a certain threshold of reliability, this certified model could then be used in future BCA 750 audits that pertain to adverse outcomes from facial recognition predictions. Certifying a data set ensures that machine learning models developed from the data set are ideally not biased, but if bias does exist it is known, documented, and can be normalized as to mitigate its effects. The certified model 783 is responsible for generating the baseline output 784 which is necessary for deriving bias of data sets as facilitated by the BCA 750.

The data set and model certification manager's 780 certification of a trained model can allow for deduction of bias via the BCA 750 in different data segments or sources by quantifying bias as it deviates from the baseline of a larger population. Larger quantities of bias result in a lower bias score 742. Furthermore, directed or random sampling processes will be used to direct comparisons to other data sets (owned or public) or to verification processes carried out internally, automatically, manually, or even directed by an external party like a customer or regulator. Within the BCA 750, all data sets linked to contaminated outcomes can be used by a certified trained model to produce an output that can be compared against the baseline output 784 of a certified model 783 characterize the bias of the contaminated data set. The bias characterization score is persisted to the data store 710 where it can be used by the data set valuation engine 740 to generate both an updated data set value score and data set value report.

### Detailed Description of Exemplary Aspects

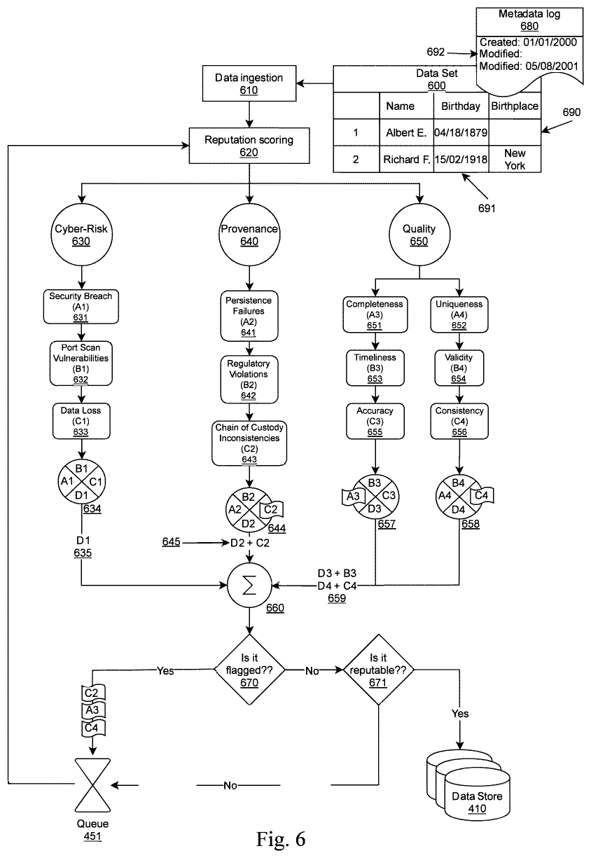

FIG. 6 is a flow diagram of a simplified dataset being processed by an exemplary embodiment of the system. According to this embodiment, a reputation scoring engine receives an ingested 610 data set 600 and begins the process of scoring 620 its reputability. Machine learning (ML) algorithms score each data set 600 entry by a plurality of metrics. These scores are represented symbolically in FIG. 6 as A1 631, B1 632, and C1 633 for cyber-risk metrics 630, A2 641, B2 642, and C2 643 for the provenance metrics 640, and A3 651, B3 653, C3 655, A4 652, B4 654, and C4 656 for the quality scoring metrics 650. All scores are summed in respective summing blocks 634,644, 657, 658 before being combined for a final score 660. After the final score is calculated 660, the reputation scoring engine sends 670 any flagged data fields and the relevant information to the verification queue 451. When no flags are identified, the overall score 660 is compared 671 against the minimum score required to be considered reputable. Data meeting the threshold goes on to be stored in a persistence layer (data store 410) where unflagged but still unreputable data is sent to the verification queue 451 for human analysis.

As a simplified example of this embodiment, consider the data set 600. The data set 600 has two errors 690,691 in the data itself, and one 692 in the metadata 680. In this example, the machine learning algorithms successfully scored security breaches (A1) 631, port scans (B1) 632, and data loss events (C1) 633 and subsequently totaled and sent the score (D1 635) to the summing block 660.

During the provenance 640 scoring routine, the ML algorithms discovered a missing entry 692 in the metadata log 680 and flagged it for the verification queue 451. When the scores are totaled, the reputation scoring engine will attach a flag to that particular erroneous entry 692 and pass that along 645 to the summing block 660.

Also regarding this example, the data quality checks 650 revealed problematic entries in the data itself. Missing information such as Albert E.'s birthplace 690 cause completeness (A3) 651 to be earmarked for review and the consistency scoring metric (C4) 656 is flagged due to inconsistent date formats (day/month/year or month/day/year). Finally, the overall reputation score is totaled 660 from the independent metric scores; D1 635, D2 645, D3, and D4 659 and flagged entry information is sent to the queue 451.

After data stewards resolve issues 690, 961, and 692, the data set 600 is received once again for reputation scoring 620. Considering all erroneous information is resolved and the data set 600 meets the threshold for reputability 671, the data set 600 is then merged with the relevant data set collection within the data store 410 or creates a new collection should one not exist.

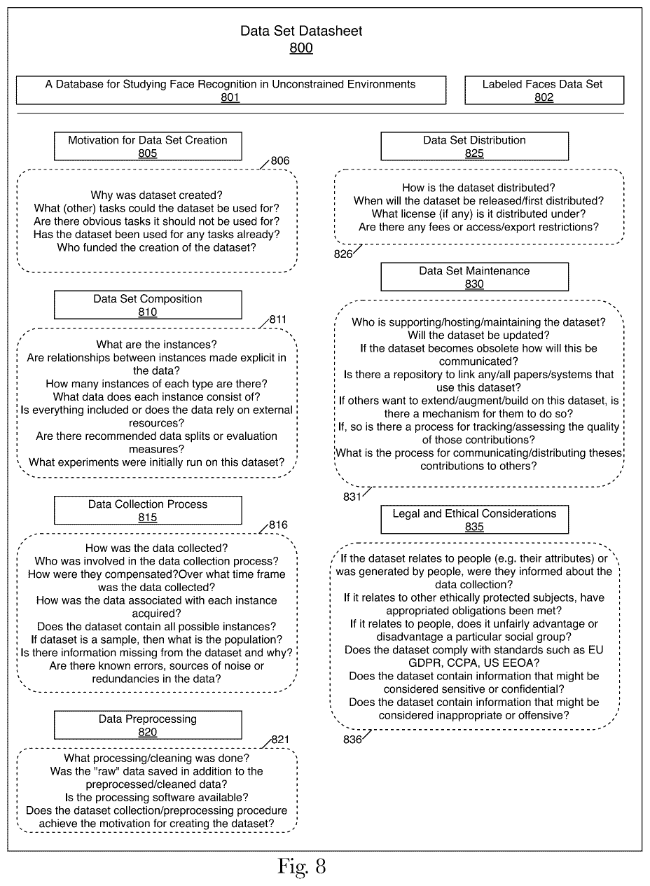

FIG. 8 is an exemplary data set datasheet as may be produced by an embodiment of the system. The data set datasheet 800 consists of a brief statement 801 as to the purpose of the data set, the name of the data set 802, and seven subsections 805, 810, 815, 820, 825, 830, and 835 that document important attributes of a data set. In this example, the brief statement 801 describes a database for studying face recognition in unconstrained environments and the name of the data set 802 is labeled faces data set. The subsections represent the central tenets of the motivation behind creating a core approach to data set documentation and are considered to be standard subsections for each datasheet. Each subsection contains standardized questions 806, 811, 816, 821, 826, 831, and 836 that data set creators will answer to the best of their abilities. The answers to the questions provided by the creators are used to categorize and register the information contained within a data set via the use of data tagging and keyword matching as the datasheet is processed. Data sets are linked with associated, tagged metadata and persisted to the data store 710.

The first subsection is to provide the motivation for data set creation 805 by way of answering the questions 806 about why the data set was created, who paid for its creation, and other use cases for the data set. This can be thought of as the introduction of the data set to the data set user as it provides background information on the purpose of the data set creation and its potential use cases.

The next subsection is for information regarding data set composition 810. The goal of this section is to provide in depth statistical analysis of the data within a data set. By answering the composition questions 811 the data set creator provides information about what types of data, the amount of data, the instances of data, initial experiments run on this data set, training/testing splits, and evaluation measures. An example of instances used could be documents, images, people, countries, and the like. Further information provided about the instances may include if there are multiple types of instances (e.g. movies, users, ratings; people, interaction between them; nodes, edges, etc.) This subsection is critical for categorizing and registering data held by data brokers and data providers alike. The instance information supplied in this section is tagged. As an example of the information provided in the data set composition 810 subsection, the datasheet for the labeled faces data set 802 would state the following about the data set: contains a pair of images labeled with the name of the person in the image, some images contain more than one face, the labeled face is the one containing the central pixel of the image, other faces should be ignored. This data set may be given an image tag and name tag to identify that the data set contains instances of images and names. This allows for quick lookup of data sets using tagged keywords which is useful for bias characterization audit 750 processes which scan for alternate data sets similar to a contaminated audited data set.

The data collection process 815 subsection and its associated question set 816 provide background on the how and who collected the data, and if there are inconsistencies, missing information, or known errors within the data set. The data preprocessing 820 section details what data cleaning techniques were used, whether the raw data can be accessed, what software was used to process the data, and if the data set preprocessing method yield a data set that can achieve its purpose for creation. The preprocessing questions 821 are helpful for tracking the provenance of data by clearly stating what intermediate processing steps were necessary to compile the data set. A datasheet that contains well documented information for this subsection can increases the value of a data set because it further boosts its data provenance score 442 and the datasheet score 771.

A data set distribution 825 subsection accompanied by its standard question set 826 provide data set users with pertinent information on the distribution procedures for a data set including any fees, licenses, or export restrictions associated with a data set's use. The following subsection provides answers to the question set 831 that have to do with data set maintenance 830. Data set maintenance 830 refers to the support and persistence of a data set. For example, maintenance questions 831 gather information on who is hosting or maintaining the data set, will the data set be updated, is there a repository to link any and all papers or systems that use this data set, and whether there is a process for extending the data set by data users and if so are there methods to assess the quality of user submitted data. The answers to these questions provide critical information in regards to the stability and long term viability of a data set, which I useful generating a value score for the data set. Particularly useful is information about other systems that have leveraged the data set. This type of knowledge is useful during a bias characterization audit 750 because if a data set has led to a contaminated decision via one system, if may also lead to bias in other systems the data set was used for. The data market system 700 can leverage its data provenance tracking and data tagging capabilities to locate alternate machine learning systems used for the contaminated data set, then the BCA 750 can determine if the bias led to contaminated outcomes in the alternate systems and assign a bias score 742.

The final subsection included in a data set datasheet provides relevant information about legal and ethical considerations 835 that regulate the use of the data contained with a data set. The legal and ethical questionnaire 836 relays important information about consent for data collection as it pertains to personal information, legal restrictions (e.g. GDPR, CCPA, etc.) that govern data use, the nature of the data contained and whether it may be sensitive, confidential, inappropriate, offensive, etc. The information from this subsection is useful for provenance scoring 442 as it details any data restrictions due to legal or geospatial constraints.

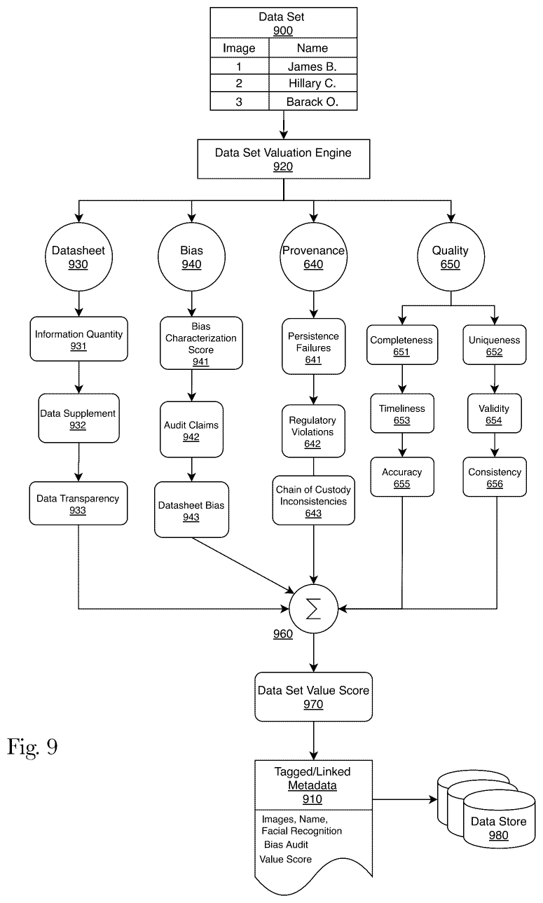

FIG. 9 is a diagram of an exemplary process flow for data set valuation and scoring. The process begins when the data set valuation 920 system receives a data set 900. The data set may be comprised of data formatted and structured in various methods known to those skilled in the arts. The data set used in this example is the same data set used in the above description of FIG. 8. The labeled faces data set consists of image and name instances. The data set valuation 920 begins scoring the data set based upon the individual scores of four scoring components. The four components of the total score are a datasheet score 930, a bias score 940, a provenance score 640, and a quality score 650. Each scoring component has metrics that are used to generate the component score. All component scores are combined 960 to generate a final data set value score 970 which is then persisted to the data store 980 as a linked metadata 910 value.

The datasheet score 930 may be comprised of, but not limited to metrics such as information quantity 931, data supplement capabilities 932, and data transparency 933 that reflect the completeness of a datasheet. The information quantity metric 931 checks if a datasheet is available for the received data set and measures the amount of datasheet subsection information made available. Since each datasheet is following a standard the subsections and the accompanying subsection questionnaires are known in advance and stored within the data set valuation 920 which can be used to facilitate and improve datasheet data extraction. For example, a datasheet that has very few missing subsection questionnaire responses would receive a higher information quantity metric score 931 than a datasheet that has many missing questionnaire responses. The data supplement metric 932 quantifies the additional bias and provenance information ascertained from the datasheet information available. All data bias and provenance information is critical for the data valuation process, so datasheets that furnish additional information about those aspects are considered more valuable and useful and are given a higher data supplement metric score 932 than data sheets that do not yield any further data. The data transparency metric 933 considers the responses to a plurality of specific datasheet questionnaire questions that relate to the creation, maintenance, distribution, and ethical considerations of the data set. A high data transparency metric score 933 correlates to a verifiable data set that can be easily used for machine learning methods and analyzed more efficiently for potential bias.

The bias score 940 may be comprised of, but not limited to metrics such as bias characterization score 941, audit claims 942, and datasheet bias 942. The bias characterization score 941 metric is based off of the initial bias characterization analysis of a data set as it is added to the data market 700 as generated by the BCA 750, both from FIG. 7. For a data set that has no datasheet or audit history information available, the bias characterization score 941 represents the full extent of any biases that may exist within the data set. If the data set has been implicated in contaminated decision, then it will have been sent through the bias characterization audit 750 and a bias characterization score was generated and linked to the data set. The number of times a data set has been involved in an audit claim 942 can lead to a lower bias score 940. A data set that had been used to generate a contaminated decision may have a lower bias score 940 than similar data sets that have not been subject to BCA 750 audit, however, an audit being performed over a data set does not necessarily result in a lower bias score 940. Lastly, datasheet bias 943 information provided by the data set creator may be used as metric. The data provenance score 640 and the data quality score 650 are described in detail above in FIG. 6.

A score is generated for each scoring category based on the associated scoring metrics. The four scoring categories, datasheet 930, bias 940, provenance 640, and quality 650 are combined 960 to form a total data set value score 970 that can be used to evaluate data sets for machine learning applications, categorize or register data sets, certify data sets, monetize data sets, and any other uses for data sets known in the arts. The data set value score 970 is linked to the data set as a metadata value 910 that can be easily searched and accessed via the data provider access portal 770, FIG. 7, and persisted to the data store 910 for further use by the system.

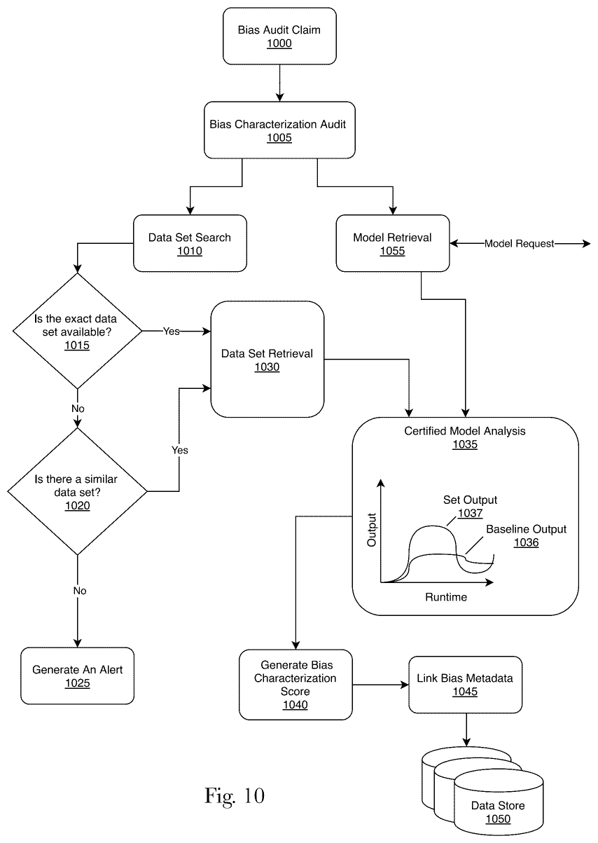

FIG. 10 is a diagram of an exemplary process flow for bias characterization and scoring of a data set. The process begins when the bias characterization audit 1005 receives a data set or a bias audit claim 1000 which can be generated from various sources such as internal, automated, manual, or directed by an external party like a customer or regulator, etc. For example, if there is a dispute over an action that relied on machine learning predictions that resulted in a contaminated outcome, then the BCA 1005 can run an audit on the disputed model, or its underlying data set, to characterize any bias that may have led to the contaminated outcome. Continuing the example from the previous figure, a movie theatre was using the facial recognition algorithm developed using the labeling faces data set to scan theatre attendees faces to verify compliance with age restrictions on movies (e.g. PG-13, R-rated films only allow certain age ranges). The system was letting in young children into R-rated films due to poor predictive skills. The theatre has been unknowingly allowing kids to access content that they should not have access to. So, this facial recognition model incorporated into a bias audit claim 1000 and sent to the BCA 1005. The audited data set is provided with the claim and forwarded to certified model analysis 1035 for further bias characterization. Then a suitable certified data set 782 and its associated certified model 784 are retrieved from storage. The certified data set 782 is used as an input to the certified model 784 and the output from that process serves as the baseline output 1036 to compare data sets for bias characterization analysis. The audited data set contained within the bias audit claim 1000 is used as input into the certified model 784 and the output from that process is referred to as the set output 1037.

If the bias audit claim did not provide the audited data set, then a data set search 1010 is conducted which can look for the to see if the exact data set 1015 can be located. If it can be then it is retrieved 1030 and sent to the CMA 1035. If an exact match cannot be located, then the system can perform a CMA 1035 on a variety of similar certified data sets 1020 if they are available. A data set can be considered similar in a variety of ways including, but not limited to a comparison of tagged metadata and keyword pairs for similarity as well as consideration of the data set value score 970, FIG. 9 within the same range. If a similar data set is found, then it is retrieved and forwarded to the CMA 1035. If a similar data set cannot be found, then an alert is generated which is sent to the data provider access portal 770, FIG. 7 which can be viewed by anyone accessing the portal. The alert may state the need for a specific data set, or type of data set, or it may ask for users to optionally submit data to compile a data set, or any other action or information.

Once all relevant data sets and certified models 784 have been retrieved the CMA 1035 can begin to characterize the bias within a data set. Contained within this diagram is a simplified CMA process 1035 used only to illustrate how a model may be characterized according to an embodiment of the system. The CMA 1035 can derive the bias of a model or data set by comparing the baseline output 1036 and the set output 1035 via a bias characterization analysis within the CMA 1035. The bias characterization analysis is able to quantify the deviations between the baseline output 1036 and the set output 1037 to characterize the inherent bias contained within a data set to generate a bias characterization score 1040 for the data set or audited data set. The baseline output 1036 allows for comparisons of contaminated sample sets against larger data set populations. The bias characterization score 1040 is linked via tagging of metadata 1045 to the evaluated data set and persisted to a data store 1050.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines, or other appropriate virtual environments).

Referring now to FIG. 11, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some aspects, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 11 illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device aspects may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

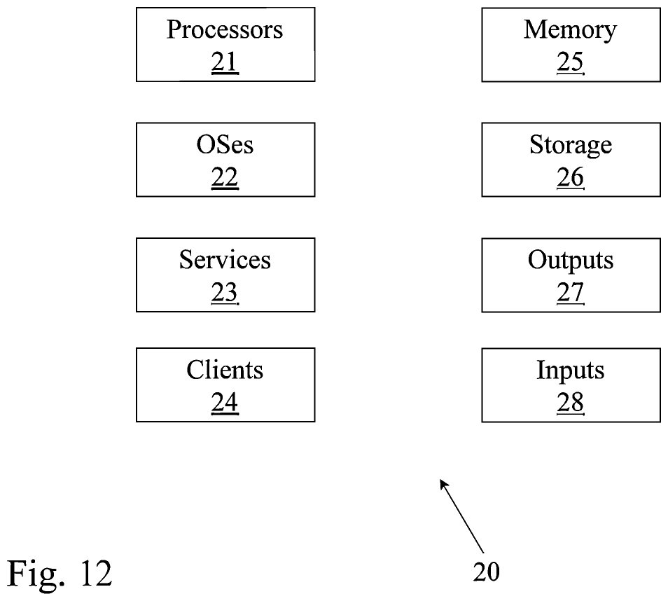

In some aspects, systems may be implemented on a standalone computing system. Referring now to FIG. 12, there is shown a block diagram depicting a typical exemplary architecture of one or more aspects or components thereof on a standalone computing system. Computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 11). Examples of storage devices 26 include flash memory, magnetic hard drive, CD-ROM, and/or the like.

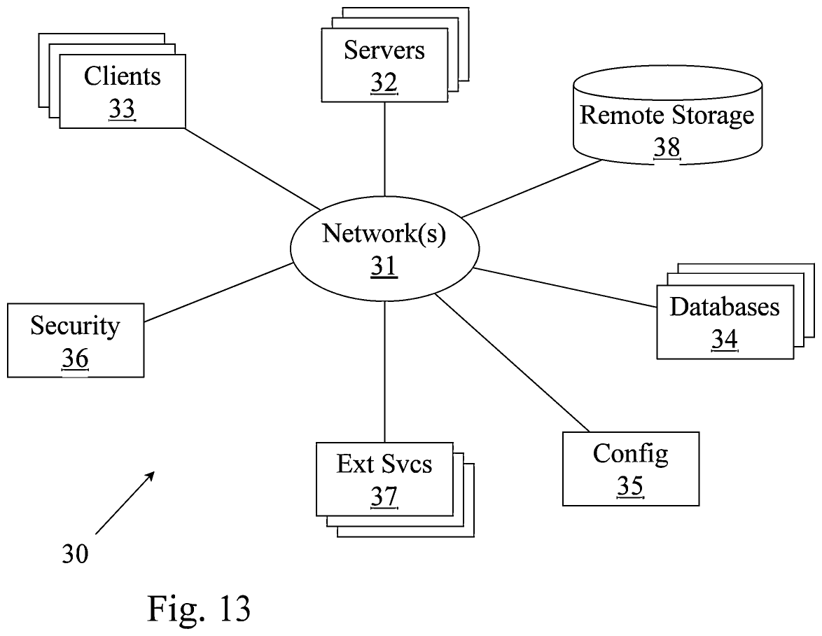

In some aspects, systems may be implemented on a distributed computing network, such as one having any number of clients and/or servers. Referring now to FIG. 13, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 11. In addition, any number of servers 32 may be provided for handling requests received from one or more clients 33. Clients 33 and servers 32 may communicate with one another via one or more electronic networks 31, which may be in various aspects any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored in a server system 32 in the cloud or on an external service 37 deployed on one or more of a particular enterprise's or user's premises. In some aspects, clients 33 or servers 32 (or both) may make use of one or more

specialized services or appliances that may be deployed locally or remotely across one or more networks 31. For example, one or more databases 34 may be used or referred to by one or more aspects. It should be understood by one having ordinary skill in the art that databases 34 may be arranged in a wide variety of architectures and using a wide variety of data access and manipulation means. For example, in various aspects one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with aspects without limitation, unless a specific security 36 or configuration system 35 or approach is specifically required by the description of any specific aspect.

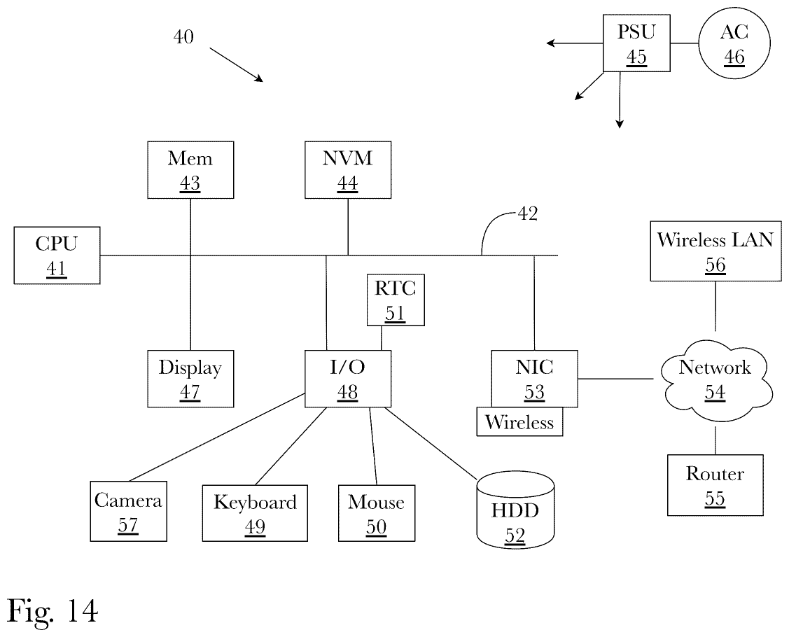

FIG. 14 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various aspects, functionality for implementing systems or methods of various aspects may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various aspects described above. Accordingly, the present invention is defined by the claims and their equivalents.

What is claimed is:

1. A system for data set validation, bias characterization, and valuation, comprising:
a computing device comprising a memory, a processor, and a non-volatile data storage device;
a data set and model certification manager comprising a first plurality of programming instructions that, when operating on the processor, cause the computing device to:
retrieve a first data set from the non-volatile data storage device;
pass the first data set through a series of filters to reduce the first data set to its core information content;
analyze the core information content to determine an information gain obtained by filtering the first data set based on an information entropy of the core information content;
certify the data set if the information gain exceeds a threshold;
create a certified model by training a machine learning algorithm with the certified data set;
use the certified model to generate a baseline output using the first data set as input; and
store the certified data set, the certified model, and the baseline output in the non-volatile data storage device; and
a bias characterization auditor comprising a second plurality of programming instructions that, when operating on the processor, cause the computing device to:
receive a second data set;
retrieve the certified model and the baseline output from the non-volatile data storage device;
use the second data set as an input to the certified model to generate a set output;
perform a bias characterization analysis by comparing the baseline output to the set output;
generate a bias characterization score from the bias characterization analysis; and
store the bias characterization score in the non-volatile data storage device; and
a data valuation engine comprising a third plurality of programming instructions that, when operating on the processor, cause the computing device to:
score the second data set based on a plurality of scoring metrics, which includes the bias characterization score and a provenance score, wherein the provenance score is determined by analyzing a plurality of provenance metrics comprising at least one of persistence failures, regulatory violations, and chain of custody inconsistencies; and
create and store a data set value score as a weighted combination of the scores of the plurality of scoring metrics.

2. The system of claim 1, wherein the value score is used as a pricing schedule for data set monetization.

3. The system of claim 1, wherein the bias characterization auditor further receives a bias audit claim containing an audited data set and performs the bias characterization analysis on the audited data set to create a bias characterization score for the audited data set.

4. The system of claim 1, wherein the second data set consists of: partial data, statistical characteristic data, synthetic data, a model characterizing synthetic data, or tokenized data.

5. The system of claim 1, further comprising a data translator comprising a fourth plurality of programming instructions stored in the memory and operating on the processor which cause the computing device to translate a data set into one or more optional data representations while maintaining links to the original source or sources of data.

6. A method for data set validation and valuation to facilitate data set and algorithm bias certification and scoring, comprising the steps of:
retrieving a first data set;
passing the first data set through a series of filters to reduce the first data set to its core information content;
analyzing the core information content to determine an information gain obtained by filtering the first data set based on an information entropy of the core information content;
certifying the data set if the information gain exceeds a threshold;
creating a certified model by training a machine learning algorithm with the certified data set;
using the certified model to generate a baseline output using the first data set as input;
storing the certified data set, certified model, and the baseline output;
receiving a second data set;
using the second data set as an input to the certified model to generate a set output;
performing a bias characterization analysis by comparing the baseline output to the set output;
generating a bias characterization score from the bias characterization analysis;
storing the bias characterization score;
scoring the second data set based on a plurality of scoring metrics, which includes the bias characterization score and a provenance score, wherein the provenance score is determined by analyzing a plurality of provenance metrics comprising at least one of persistence failures, regulatory violations, and chain of custody inconsistencies; and
creating and storing a data set value score as a weighted combination of the scores of the plurality of scoring metrics.

7. The method of claim 6, wherein the value score is used as a pricing schedule for data set monetization.

8. The method of claim 6, further comprising the steps of receiving a bias audit claim containing an audited data set and performing the bias characterization analysis on the audited data set to create a bias characterization score for the audited data set.

9. The method of claim 6, wherein the second data set consists of: partial data, statistical characteristic data, synthetic data, a model characterizing synthetic data, or tokenized data.

10. The method of claim 6, further comprising a data translator further comprising the steps of translating a data set into one or more optional data representations while maintaining links to the original source or sources of data.
